(19) United States
(12) Patent Application Publication
(10) Pub. No.: US 2026/0105246 A1
(43) Pub. Date: Apr. 16, 2026

(54) DATA PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Yao TONG, Beijing (CN); Mingjun YANG, Beijing (CN); Chong MA, Beijing (CN); Jin ZHANG, Beijing (CN); Yu CAO, Beijing (CN); Wei CAI, Beijing (CN); Xiaoliang LI, Beijing (CN); Gang WANG, Beijing (CN); Jiekai FU, Beijing (CN); Wenbo LUO, Beijing (CN); Huiyang ZHONG, Beijing (CN); Zhongyao YANG, Beijing (CN)

(21) Appl. No.: 19/115,244

(22) PCT Filed: Sep. 22, 2023
(86) PCT No.: PCT/CN2023/120530

§ 371 Date: Mar. 25, 2025

(30) Foreign Application Priority Data
Oct. 13, 2022 (CN) 202211254216.1

(51) Int. Cl. G06F 40/166

(52) U.S. Cl. CPC G06F 40/166

(57) ABSTRACT

The present disclosure provides a data processing method, apparatus, an electronic device, and a storage medium. The data processing method includes: displaying a preset component in a document editing interface; in response to a trigger operation on the preset component, displaying at least one selectable revision record; and in response to a trigger operation on at least one selected revision record, updating display content of the document editing interface.

### CROSS-REFERENCE TO RELATED APPLICATION(S)

The present application is based on and claims priority to Chinese Application No. 202211254216.1, filed on Oct. 13, 2022, which is incorporated herein by reference in its entirety.

### TECHNICAL FIELD

The present disclosure relates to the field of computer technologies, and in particular, to a data processing method, apparatus, an electronic device, and a storage medium.

### BACKGROUND

When a user performs revision operations such as adding, deleting and modifying on a document through a document editor, the document editor records revision content and displays the revision content in the form of a comment box. The user can choose to process a certain revision record or all revision records.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides a data processing method, apparatus, an electronic device, and a storage medium.

The present disclosure uses the following technical solutions.

In some embodiments, the present disclosure provides a data processing method, including:
displaying a preset component in a document editing interface;
in response to a trigger operation on the preset component, displaying at least one selectable revision record; and
in response to a trigger operation on at least one selected revision record, updating display content of the document editing interface.

In some embodiments, the present disclosure provides a data processing apparatus, including:
a first display module configured to display a preset component in a document editing interface;
a second display module configured to, in response to a trigger operation on the preset component, display at least one selectable revision record; and
a processing module configured to, in response to a trigger operation on at least one selected revision record, update display content of the document editing interface.

In some embodiments, the present disclosure provides an electronic device, including at least one memory and at least one processor,
where the memory is configured to store program code, and the processor is configured to call the program code stored in the memory to perform the above method.

In some embodiments, the present disclosure provides a non-transitory computer-readable storage medium storing program code that, when run by a processor, causes the processor to perform the above method.

In some embodiments, the present disclosure provides a computer program product that, when executed by a processor, implements the data processing method according to any one of the above embodiments.

### BRIEF DESCRIPTION OF THE DRAWINGS

The above and other features, advantages, and aspects of embodiments of the present disclosure become more apparent with reference to the following specific implementations in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a flowchart of a data processing method according to an embodiment of the present disclosure.

FIG. 2 is a schematic diagram of a structure of a data processing apparatus according to an embodiment of the present disclosure.

FIG. 3 is a schematic diagram of a structure of an electronic device according to an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that the various steps described in the method implementations of the present disclosure may be performed in chronological order and/or in parallel. Additionally, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below. The term “in response to” and related terms mean that one signal or event is affected to a certain extent by another signal or event, but not necessarily completely or directly affected. If event x occurs “in response to” event y, x may directly or indirectly respond to y. For example, the occurrence of y may eventually cause the occurrence of x, but there may be other intermediate events and/or conditions. In other cases, y may not necessarily cause the occurrence of x, and x may occur even if y has not occurred. In addition, the term “in response to” may also mean “at least partially in response to”.

The term “determine” encompasses a wide variety of actions and, for example, may include acquiring, calculating, computing, processing, deriving, investigating, looking up (for example, looking up in a table, a database or another data structure), ascertaining, and similar actions, and may also include receiving (for example, receiving information), accessing (for example, accessing data in a memory), and similar actions, and resolving, selecting, choosing, establishing, and similar actions, and the like. Related definitions of the other terms will be given in the description below. Related definitions of the other terms will be given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that the modifier “one” mentioned in the present disclosure is illustrative and not restrictive, and those skilled in the art should understand that unless the context clearly indicates otherwise, it should be understood as “one or more”.

The names of messages or information exchanged between a plurality of apparatuses in the implementations of the present disclosure are used for illustrative purposes only, and are not used to limit the scope of these messages or information.

A solution provided in the embodiments of the present disclosure is described in detail below with reference to the accompanying drawings.

The document revision function provided in the related art requires a user to perform an operation judgment on revision records one by one, or to accept/reject all revision records with one click, has no capability of batch processing some revision records, and cannot be applied to actual operation requirements of users in scenarios such as contract negotiation.

The data processing method according to the embodiments of the present disclosure displays a preset component in a document editing interface; in response to a trigger operation on the preset component, displays at least one selectable revision record; and in response to a trigger operation on at least one selected revision record, updates display content of the document editing interface. The data processing method according to the embodiments of the present disclosure can flexibly perform batch processing on selected revision records, improve document processing efficiency, and implement a function of batch processing an undetermined number of document revision records.

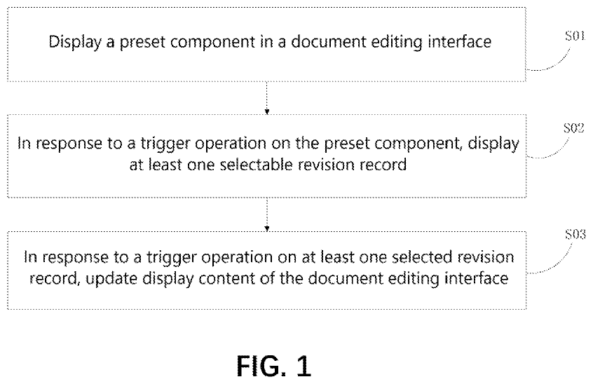

As shown in FIG. 1, FIG. 1 is a flowchart of a data processing method according to an embodiment of the present disclosure, and includes the following steps.

Step S01: Display a preset component in a document editing interface;

In some embodiments, the preset component is displayed at a preset position in a document editing interface of an application. For example, the preset component is displayed in an edit panel in the document editing interface, or the preset component is displayed in a function bar in a document boundary interface. The preset component is used for a user to perform batch operations on revision records.

In some embodiments, when the user opens the edit panel in the document editing interface, the preset component may display reminder information, and the reminder information may be a message box including batch processing.

Step S02: In response to a trigger operation on the preset component, display at least one selectable revision record;

In some embodiments, when a trigger operation on the preset component is responded to, function options corresponding to the preset component, that is, batch processing a first revision record and batch processing a second revision record, are displayed. Specifically, when a trigger operation on an option of batch processing the first revision record is responded to, at least one selectable first revision record is displayed; and when a trigger operation on an option of batch processing the second revision record is responded to, at least one selectable second revision record is displayed.

In some embodiments, when a trigger operation on an option of batch processing the first revision record is responded to, all revision records corresponding to a document are displayed, and the first revision record in the revision records is set as a selectable revision record; or when a trigger operation on an option of batch processing the second revision record is responded to, all revision records corresponding to the document are displayed, and the second revision record in the revision records is set as a selectable revision record.

Step S03: In response to a trigger operation on at least one selected revision record, update display content of the document editing interface.

In some embodiments, in response to a trigger operation on at least one selected revision record, display content of the document editing interface is updated. Specifically, in response to a batch accept operation or a batch reject operation on at least one selected first revision record, corresponding document content and a current display state of the first revision record are updated. In response to a batch processing operation on at least one selected second revision record, a current display state of the second revision record is updated.

The data processing method according to the embodiments of the present disclosure displays a preset component in a document editing interface; in response to a trigger operation on the preset component, displays at least one selectable revision record; and in response to a trigger operation on at least one selected revision record, updates display content of the document editing interface. The data processing method according to the embodiments of the present disclosure can flexibly perform batch processing on selected revision records, improve document processing efficiency, and implement a function of batch processing an undetermined number of document revision records.

In some embodiments, the method further includes:
in response to a trigger operation on the selected revision record, displaying text display content corresponding to the revision record in a preset selected style.

In some embodiments, in response to a trigger operation on a current revision record, corresponding text is highlighted in a document editor. A text display style corresponding to the selected revision record is not specifically displayed.

In some embodiments, the displaying a preset component in a document editing interface includes:
displaying the preset component in an edit panel of the document editing interface, where the edit panel includes at least one revision record.

In some embodiments, when the user opens the edit panel in the document editing interface, the preset component is displayed in the edit panel, and the edit panel is configured to display at least one revision record corresponding to a document.

In some embodiments,
the revision record includes a first revision record and a second revision record; and
the first revision record includes an adding revision record and/or a deleting revision record, and the second revision record includes a comment revision record.

In some embodiments, revision of a document includes an adding revision record of adding content to the document, a deleting revision record of deleting content from the document, and a comment revision record added to specific content in the document.

In some embodiments, the in response to a trigger operation on the preset component, displaying at least one selectable revision record includes:
in response to an operation of batch processing the first revision record on the preset component, displaying at least one selectable first revision record; or in response to an operation of batch processing the second revision record on the preset component, displaying at least one selectable second revision record.

In some embodiments, when a trigger operation on the preset component is responded to, function options corresponding to the preset component, that is, batch processing a first revision record and batch processing a second revision record, are displayed. Specifically, when a trigger operation on an option of batch processing the first revision record is responded to, at least one selectable first revision record is displayed; and when a trigger operation on an option of batch processing the second revision record is responded to, at least one selectable second revision record is displayed.

In some embodiments, when a trigger operation on an option of batch processing the first revision record is responded to, all revision records corresponding to a document are displayed, and the first revision record in the revision records is set as a selectable revision record; or when a trigger operation on an option of batch processing the second revision record is responded to, all revision records corresponding to the document are displayed, and the second revision record in the revision records is set as a selectable revision record.

In some embodiments, the in response to an operation of batch processing the first revision record on the preset component, displaying at least one selectable first revision record includes:
in response to an operation of batch processing the first revision record on the preset component, displaying at least one selectable adding revision record and/or deleting revision record.

In some embodiments, when a trigger operation on a batch processing revision function option of the preset component is responded to, at least one selectable adding revision record and/or deleting revision record corresponding to a current document is displayed.

In some embodiments, the in response to an operation of batch processing the second revision record on the preset component, displaying at least one selectable second revision record includes:
in response to an operation of batch processing the second revision record on the preset component, displaying at least one selectable comment revision record.

In some embodiments, when a trigger operation on a batch processing comment function option of the preset component is responded to, at least one selectable comment revision record corresponding to a current document is displayed.

In some embodiments, the in response to a trigger operation on at least one selected revision record, updating display content of the document editing interface includes:
in response to a trigger operation on at least one selected first revision record, updating document content corresponding to the first revision record and/or display content of the first revision record in the document editing interface.

In some embodiments, the in response to a trigger operation on at least one selected revision record, updating display content of the document editing interface includes:
in response to a trigger operation on at least one selected second revision record, updating display content of the second revision record.

In some embodiments, in response to a batch accept operation or a batch reject operation on at least one selected first revision record, corresponding document content and a current display state of the first revision record are updated. In response to a batch processing operation on at least one selected second revision record, a current display state of the second revision record is updated. Updating the current display state of the first revision record and updating the current display state of the second revision record may be adding completed identification information at a preset position of the first revision record or adding completed identification information at a preset position of the second revision record. Alternatively, display colors of the first revision record and the second revision record are updated.

In some embodiments, a user can select batch processing revision or batch processing comment through the preset component displayed in the document editing interface, and perform batch processing and judgment on an unprocessed record that is selected. When the user selects a specific revision record, corresponding content in the document is located through scrolling and displayed in a highlighted form, to implement state linkage. When the user triggers a batch processing revision operation, undetermined batch accept/reject processing is performed. When the user triggers a batch processing comment revision operation, undetermined batch processing is performed. The data processing method according to the embodiments of the present disclosure can process a revision and comment record of a document more efficiently and quickly, and has strong practicability.

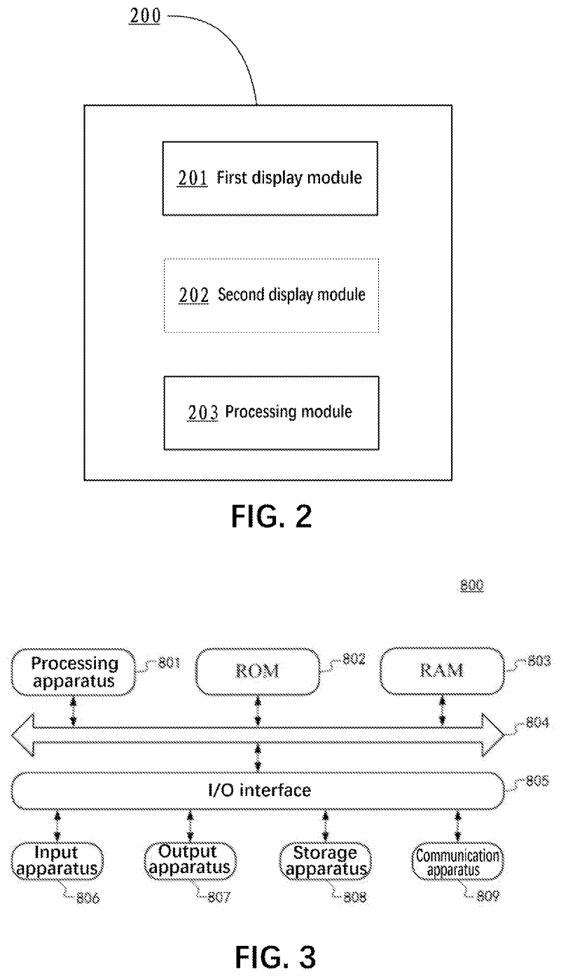

The embodiments of the present disclosure further provide a data processing apparatus 200. As shown in FIG. 2, the data processing apparatus 200 includes:
a first display module 201 configured to display a preset component in a document editing interface;
a second display module 202 configured to, in response to a trigger operation on the preset component, display at least one selectable revision record; and
a processing module 203 configured to, in response to a trigger operation on at least one selected revision record, update display content of the document editing interface.

In some embodiments, the processing module is further configured to, in response to a trigger operation on the selected revision record, display text display content corresponding to the revision record in a preset selected style.

In some embodiments, the first display module is further configured to display the preset component in an edit panel of the document editing interface, where the edit panel includes at least one revision record.

In some embodiments, the revision record includes a first revision record and a second revision record; and
the first revision record includes an adding revision record and/or a deleting revision record, and the second revision record includes a comment revision record.

In some embodiments, the second display module is further configured to, in response to an operation of batch processing the first revision record on the preset component, display at least one selectable first revision record; or in response to an operation of batch processing the second revision record on the preset component, display at least one selectable second revision record.

In some embodiments, the second display module is further configured to, in response to an operation of batch processing the first revision record on the preset component, display at least one selectable adding revision record and/or deleting revision record.

In some embodiments, the second display module is further configured to, in response to an operation of batch processing the second revision record on the preset component, display at least one selectable comment revision record.

In some embodiments, the processing module is further configured to, in response to a trigger operation on at least one selected first revision record, update document content corresponding to the first revision record and/or display content of the first revision record in the document editing interface.

In some embodiments, the processing module is further configured to, in response to a trigger operation on at least one selected second revision record, update display content of the second revision record.

For an implementation of the apparatus, because it is basically similar to the implementation of the method, reference may be made to some descriptions of the implementation of the method. The apparatus embodiments described above are merely illustrative, and the modules described as separate parts may or may not be physically separate. Some or all of the modules may be selected according to actual needs to achieve the objectives of the solutions of the embodiments. A person of ordinary skill in the art can understand and implement the embodiments of the present disclosure without creative efforts.

The method and apparatus of the present disclosure are described above based on the embodiments and application examples. In addition, the present disclosure further provides an electronic device and a non-transitory computer-readable storage medium. The electronic device and the non-transitory computer-readable storage medium are described below.

Reference is made to FIG. 3 below, which is a schematic diagram of a structure of an electronic device (for example, a terminal device or a server) 800 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (for example, a central processing unit, a graphics processing unit, etc.) 801 that may perform a variety of appropriate actions and processing in accordance with a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (LCD), a speaker, a vibrator, etc.; the storage apparatus 808 including, for example, a tape and a hard disk, etc.; and a communication apparatus 809. The communication apparatus 809 may allow the electronic device 800 to perform wireless or wired communication with other devices to exchange data. Although the electronic device 800 with various apparatuses is shown in the figure, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 809, or installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method of the present disclosure.

The computer program code for performing operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in a reverse order, depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by software, or may be implemented by hardware. The name of the unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on a chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, a data processing method is provided, including:
displaying a preset component in a document editing interface;
in response to a trigger operation on the preset component, displaying at least one selectable revision record; and
in response to a trigger operation on at least one selected revision record, updating display content of the document editing interface.

According to one or more embodiments of the present disclosure, a method is provided, further including:
in response to a trigger operation on the selected revision record, displaying text display content corresponding to the revision record in a preset selected style.

According to one or more embodiments of the present disclosure, a method is provided, where the displaying a preset component in a document editing interface includes:
displaying the preset component in an edit panel of the document editing interface, where the edit panel includes at least one revision record.

According to one or more embodiments of the present disclosure, a method is provided,
the revision record includes a first revision record and a second revision record; and
the first revision record includes an adding revision record and/or a deleting revision record, and the second revision record includes a comment revision record.

According to one or more embodiments of the present disclosure, a method is provided, where the in response to a trigger operation on the preset component, displaying at least one selectable revision record includes:
in response to an operation of batch processing the first revision record on the preset component, displaying at least one selectable first revision record; or in response to an operation of batch processing the second revision record on the preset component, displaying at least one selectable second revision record.

According to one or more embodiments of the present disclosure, a method is provided, where the in response to an operation of batch processing the first revision record on the preset component, displaying at least one selectable first revision record includes:
in response to an operation of batch processing the first revision record on the preset component, displaying at least one selectable adding revision record and/or deleting revision record.

According to one or more embodiments of the present disclosure, a method is provided, where the in response to an operation of batch processing the second revision record on the preset component, displaying at least one selectable second revision record includes:
in response to an operation of batch processing the second revision record on the preset component, displaying at least one selectable comment revision record.

According to one or more embodiments of the present disclosure, a method is provided, where the in response to a trigger operation on at least one selected revision record, updating display content of the document editing interface includes:
in response to a trigger operation on at least one selected first revision record, updating document content corresponding to the first revision record and/or display content of the first revision record in the document editing interface.

According to one or more embodiments of the present disclosure, a method is provided, where the in response to a trigger operation on at least one selected revision record, updating display content of the document editing interface includes:
in response to a trigger operation on at least one selected second revision record, updating display content of the second revision record.

According to one or more embodiments of the present disclosure, a data processing apparatus is provided, including:
a first display module configured to display a preset component in a document editing interface;
a second display module configured to, in response to a trigger operation on the preset component, display at least one selectable revision record; and
a processing module configured to, in response to a trigger operation on at least one selected revision record, update display content of the document editing interface.

According to one or more embodiments of the present disclosure, an electronic device is provided, including at least one memory and at least one processor,
where the at least one memory is configured to store program code, and the at least one processor is configured to call the program code stored in the at least one memory to perform the method according to any one of the above items.

According to one or more embodiments of the present disclosure, a non-transitory computer-readable storage medium is provided, where the computer-readable storage medium is configured to store program code that, when run by a processor, causes the processor to perform the above method.

According to one or more embodiments of the present disclosure, a computer program product is provided that, when executed by a processor, implements the data processing method described above.

The above description is merely a preferred embodiment of the present disclosure and an illustration of the applied technical principles. A person skilled in the art should understand that the scope of disclosure involved in the present disclosure is not limited to the technical solution formed by a specific combination of the above technical features, and shall also cover other technical solutions formed by any combination of the above technical features or equivalent features thereof without departing from the above disclosure concept. For example, a technical solution formed by replacing the above features with technical features with similar functions disclosed in the present disclosure (but not limited thereto).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in multiple embodiments individually or in any suitable subcombination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. A data processing method, comprising:
displaying a preset component in a document editing interface;
in response to a trigger operation on the preset component, displaying at least one selectable revision record; and
in response to a trigger operation on at least one selected revision record, updating display content of the document editing interface.

2. The method according to claim 1, further comprising:
in response to a trigger operation on the selected revision record, displaying text display content corresponding to the revision record in a preset selected style.

3. The method according to claim 1, wherein the displaying a preset component in a document editing interface comprises:
displaying the preset component in an edit panel of the document editing interface, wherein the edit panel comprises at least one revision record.

4. The method according to claim 3, wherein
the revision record comprises a first revision record and a second revision record; and
the first revision record comprises at least one of an adding revision record and a deleting revision record, and the second revision record comprises a comment revision record.

5. The method according to claim 4, wherein the in response to a trigger operation on the preset component, displaying at least one selectable revision record comprises:
in response to an operation of batch processing the first revision record on the preset component, displaying at least one selectable first revision record; or in response to an operation of batch processing the second revision record on the preset component, displaying at least one selectable second revision record.

6. The method according to claim 5, wherein the in response to an operation of batch processing the first revision record on the preset component, displaying at least one selectable first revision record comprises:
in response to an operation of batch processing the first revision record on the preset component, displaying at least one selectable adding revision record and/or deleting revision record.

7. The method according to claim 5, wherein the in response to an operation of batch processing the second revision record on the preset component, displaying at least one selectable second revision record comprises:
in response to an operation of batch processing the second revision record on the preset component, displaying at least one selectable comment revision record.

8. The method according to claim 6, wherein the in response to a trigger operation on at least one selected revision record, updating display content of the document editing interface comprises:
in response to a trigger operation on at least one selected first revision record, updating document content corresponding to the first revision record and/or display content of the first revision record in the document editing interface.

9. The method according to claim 7, wherein the in response to a trigger operation on at least one selected revision record, updating display content of the document editing interface comprises:
in response to a trigger operation on at least one selected second revision record, updating display content of the second revision record.

10. (canceled)

11. An electronic device, comprising:
at least one memory and at least one processor,
wherein the at least one memory is configured to store program code, and the at least one processor is configured to call the program code stored in the at least one memory to perform a method comprising:
displaying a preset component in a document editing interface;
in response to a trigger operation on the preset component, displaying at least one selectable revision record; and
in response to a trigger operation on at least one selected revision record, updating display content of the document editing interface.

12. A non-transitory computer-readable storage medium, wherein the computer-readable storage medium is configured to store program code that, when run by a computer device, causes the computer device to perform a method comprising:
displaying a preset component in a document editing interface;
in response to a trigger operation on the preset component, displaying at least one selectable revision record; and
in response to a trigger operation on at least one selected revision record, updating display content of the document editing interface.

13. (canceled)

14. The electronic device according to claim 11, wherein the method further comprises:
in response to a trigger operation on the selected revision record, displaying text display content corresponding to the revision record in a preset selected style.

15. The electronic device according to claim 11, wherein the displaying a preset component in a document editing interface comprises:
displaying the preset component in an edit panel of the document editing interface, wherein the edit panel comprises at least one revision record.

16. The electronic device according to claim 15, wherein
the revision record comprises a first revision record and a second revision record; and
the first revision record comprises at least one of an adding revision record and a deleting revision record, and the second revision record comprises a comment revision record.

17. The electronic device according to claim 16, wherein the in response to a trigger operation on the preset component, displaying at least one selectable revision record comprises:
in response to an operation of batch processing the first revision record on the preset component, displaying at least one selectable first revision record; or in response to an operation of batch processing the second revision record on the preset component, displaying at least one selectable second revision record.

18. The electronic device according to claim 17, wherein the in response to an operation of batch processing the first revision record on the preset component, displaying at least one selectable first revision record comprises:
in response to an operation of batch processing the first revision record on the preset component, displaying at least one selectable adding revision record and/or deleting revision record.

19. The electronic device according to claim 17, wherein the in response to an operation of batch processing the second revision record on the preset component, displaying at least one selectable second revision record comprises:
in response to an operation of batch processing the second revision record on the preset component, displaying at least one selectable comment revision record.

20. The electronic device according to claim 18, wherein the in response to a trigger operation on at least one selected revision record, updating display content of the document editing interface comprises:
in response to a trigger operation on at least one selected first revision record, updating document content corresponding to the first revision record and/or display content of the first revision record in the document editing interface.

21. The electronic device according to claim 19, wherein the in response to a trigger operation on at least one selected revision record, updating display content of the document editing interface comprises:
in response to a trigger operation on at least one selected second revision record, updating display content of the second revision record.

22. A non-transitory computer-readable storage medium, wherein the computer-readable storage medium is configured to store program code that, when run by a computer device, causes the computer device to perform the method according to claim 2.
